(19) United States
(12) Patent Application Publication
(10) Pub. No.: US 2016/0378301 A1
(43) Pub. Date: Dec. 29, 2016

(54) SCREEN INFORMATION PROCESSING APPARATUS, SCREEN INFORMATION PROCESSING METHOD, AND SCREEN INFORMATION PROCESSING PROGRAM

(71) Applicant: SUMITOMO ELECTRIC INDUSTRIES, LTD., Osaka-shi (JP)

(72) Inventor: Mitsuru HIRAKAWA, Osaka-shi (JP)

(21) Appl. No.: 15/037,761

(22) PCT Filed: Jul. 17, 2015
(86) PCT No.: PCT/JP2015/070508

§ 371 Date: May 19, 2016

(30) Foreign Application Priority Data
Mar. 3, 2015 (JP) 2015-040826

(51) Int. Cl. G06F 3/0481; G06F 7/08; G06F 3/0482; G06F 3/0484

(52) U.S. Cl. CPC G06F 3/04817; G06F 3/04845; G06F 7/08; G06F 3/0482

(57) ABSTRACT

Provided are a screen information processing apparatus, a screen information processing method, and a screen information processing program, which are capable of improving visibility in a configuration where icons respectively indicating the positions of sensors in a predetermined area are displayed on a screen. The screen information processing apparatus includes: an evaluation unit configured to, when a plurality of icons respectively indicating positions of a plurality of sensors are to be displayed on a screen, evaluate an overlapping degree or crowdedness of the icons on the screen; and a display control unit configured to perform control of displaying, on the screen, an auxiliary icon which is a separate icon that groups the icons in accordance with a content of the evaluation performed by the evaluation unit.

### TECHNICAL FIELD

The present invention relates to a screen information processing apparatus, a screen information processing method, and a screen information processing program, and in particular, relates to a screen information processing apparatus, a screen information processing method, and a screen information processing program which are for displaying icons.

### BACKGROUND ART

Various technologies for monitoring the state of a monitoring target in a predetermined area have been developed. For example, Japanese Laid-Open Patent Publication No. 2006-208000 (Patent Literature 1) discloses the following technology. That is, an airflow distribution apparatus to be used in a data center, the airflow distribution apparatus including: at least one airflow sensor coupled to a plurality of fans in at least one server in the data center; and a controller which is coupled to the at least one airflow sensor and which is configured to monitor airflow for the plurality of fans and to control cooling in the data center in accordance with detected airflow.

### CITATION LIST

### Patent Literature

PATENT LITERATURE 1: Japanese Laid-Open Patent Publication No. 2006-208000

### SUMMARY OF INVENTION

### Technical Problem

In order to monitor the state of a monitoring target in a predetermined area, there are cases where the arrangement of sensors in the predetermined area is displayed on a screen. In such a case, if a plurality of sensors are arranged in a concentrated manner, a plurality of icons respectively representing the plurality of sensors overlap each other or are crowded on the screen, and thus, visibility is reduced.

The present invention has been made in order to solve the above problem. An object of the present invention is to provide a screen information processing apparatus, a screen information processing method, and a screen information processing program which are capable of improving visibility in a configuration where icons respectively representing sensors in a predetermined area are displayed on a screen.

### Solution to Problem

(1) In order to solve the above problem, a screen information processing apparatus according to an aspect of the present invention includes: an evaluation unit configured to, when a plurality of icons respectively indicating positions of a plurality of sensors are to be displayed on a screen, evaluate an overlapping degree or crowdedness of the icons on the screen; and a display control unit configured to perform control of displaying, on the screen, an auxiliary icon which is a separate icon that groups the icons in accordance with a content of the evaluation performed by the evaluation unit.

(8) In order to solve the above problem, a screen information processing method according to an aspect of the present invention is a screen information processing method to be used in a screen information processing apparatus, the method including the steps of: evaluating, when a plurality of icons respectively indicating positions of a plurality of sensors are to be displayed on a screen, an overlapping degree or crowdedness of the icons on the screen; and performing control of displaying, on the screen, an auxiliary icon which is a separate icon that groups the icons in accordance with a content of the evaluation of the overlapping degree or the crowdedness.

(9) In order to solve the above problem, a screen information processing program according to an aspect of the present invention is a screen information processing program to be used in a screen information processing apparatus, the program causing a computer to execute the steps of: evaluating, when a plurality of icons respectively indicating positions of a plurality of sensors are to be displayed on a screen, an overlapping degree or crowdedness of the icons on the screen; and performing control of displaying, on the screen, an auxiliary icon which is a separate icon that groups the icons in accordance with a content of the evaluation of the overlapping degree or the crowdedness.

### Advantageous Effects of Invention

According to the present invention, visibility can be improved in a configuration where icons respectively indicating the positions of sensors in a predetermined area are displayed on a screen.

### BRIEF DESCRIPTION OF DRAWINGS

FIG. 1 shows a configuration of a monitoring system according to a first embodiment of the present invention.

FIG. 2 shows one example of a screen displayed on a display in a comparative example of the monitoring system according to the first embodiment of the present invention.

FIG. 3 shows one example of a screen displayed on the display in the monitoring system according to the first embodiment of the present invention.

FIG. 4 shows another example of a screen displayed on the display in the monitoring system according to the first embodiment of the present invention.

FIG. 5 shows another example of the screen displayed on the display in the monitoring system according to the first embodiment of the present invention.

FIG. 6 shows another example of the screen displayed on the display in the monitoring system according to the first embodiment of the present invention.

FIG. 7 shows another example of the screen displayed on the display in the monitoring system according to the first embodiment of the present invention.

FIG. 8 shows another example of the screen displayed on the display in the monitoring system according to the first embodiment of the present invention.

FIG. 9 shows a configuration of a screen information processing apparatus in the monitoring system according to the first embodiment of the present invention.

FIG. 10 is a flow chart showing one example of a displaying process performed by the screen information processing apparatus according to the first embodiment of the present invention.

FIG. 11 is a flow chart showing another example of the displaying process performed by the screen information processing apparatus according to the first embodiment of the present invention.

FIG. 12 shows one example of a screen displayed on the display in a monitoring system according to a second embodiment of the present invention.

FIG. 13 shows a configuration of a screen information processing apparatus according to the second embodiment of the present invention.

FIG. 14 shows one example of a screen displayed on the display in a comparative example of a monitoring system according to a third embodiment of the present invention.

FIG. 15 shows one example of a screen displayed on the display in the monitoring system according to the third embodiment of the present invention.

### DESCRIPTION OF EMBODIMENTS

First, the contents of embodiments of the present invention will be listed and described.

(1) A screen information processing apparatus according to an embodiment of the present invention includes: an evaluation unit configured to, when a plurality of icons respectively indicating positions of a plurality of sensors are to be displayed on a screen, evaluate an overlapping degree or crowdedness of the icons on the screen; and a display control unit configured to perform control of displaying, on the screen, an auxiliary icon which is a separate icon that groups the icons in accordance with a content of the evaluation performed by the evaluation unit.

With this configuration, for example, in such a case where a plurality of sensors are arranged in a concentrated manner in a predetermined area, a plurality of icons that are concentrated on the screen indicating the predetermined area can be grouped to be displayed in the form of a separate icon. Accordingly, for example, it is possible to display icons so as not to overlap each other, and it is possible to secure to some extent the distance between icons. Thus, visibility can be improved in a configuration where icons respectively indicating the positions of sensors in a predetermined area are displayed on a screen.

(2) Preferably, the screen information processing apparatus further includes an obtainment unit configured to obtain sensor information indicating a measurement result of each sensor, wherein when an icon has been designated on the screen, the display control unit performs control of displaying, on the screen, the sensor information that corresponds to the icon.

With this configuration, a user can easily confirm sensor information of a desired sensor. In this embodiment, “an icon is designated on the screen” means that an icon is designated through an operational input using a GUI (graphical user interface), such as a click operation by use of a mouse or a tapping operation onto a touch panel, for example.

(3) Preferably, the display control unit performs control of displaying the auxiliary icon assigned with the number of the icons that have been grouped thereinto.

With this configuration, the user can recognize at a glance how many icons have been grouped into an auxiliary icon, without performing a special operation.

(4) Preferably, when the auxiliary icon has been designated on the screen, the display control unit performs control of displaying an enlarged view of an arrangement area of the sensors that correspond to the auxiliary icon, together with the icons that correspond to the auxiliary icon.

With this configuration, the user can confirm, on the enlarged view, the icons that have been grouped into the auxiliary icon, and thus, can recognize the specific position of each icon.

(5) Preferably, when the auxiliary icon has been designated on the screen on which a plan view of an arrangement area of the sensors has been displayed, the display control unit performs control of displaying a side view of the arrangement area of the sensors that correspond to the auxiliary icon, together with the icons that correspond to the auxiliary icon.

With this configuration, for example, in such a case where icons that correspond to a plurality of sensors arranged at substantially the same position in the horizontal direction and at different positions in the height direction are grouped into an auxiliary icon, the user can confirm, on the side view, the icons that have been grouped into the auxiliary icon, and thus, can recognize the specific position of each icon.

(6) Preferably, when the auxiliary icon has been designated on the screen, the display control unit performs control of displaying a list of information of the sensors that correspond to the auxiliary icon.

With this configuration, the user can view the listed information regarding the plurality of sensors that correspond to the auxiliary icon.

(7) More preferably, the sensors are provided in a plurality of types, and the display control unit performs control of selectively displaying or selectively not displaying the icons that correspond to the sensor of the type designated on the screen.

With this configuration, for example, in a case where a plurality of types of icons overlap each other or are crowded, the types of the icons to be displayed on the screen can be limited, and thus, visibility can be further increased.

(8) A screen information processing method according to an embodiment of the present invention is a screen information processing method to be used in a screen information processing apparatus, the method including the steps of: evaluating, when a plurality of icons respectively indicating positions of a plurality of sensors are to be displayed on a screen, an overlapping degree or crowdedness of the icons on the screen; and performing control of displaying, on the screen, an auxiliary icon which is a separate icon that groups the icons in accordance with a content of the evaluation of the overlapping degree or the crowdedness.

With this configuration, for example, in such a case where a plurality of sensors are arranged in a concentrated manner in a predetermined area, a plurality of icons that are concentrated on the screen indicating the predetermined area can be grouped to be displayed in the form of a separate icon. Accordingly, for example, it is possible to display icons so as not to overlap each other, and it is possible to secure to some extent the distance between icons. Thus, visibility can be improved in a configuration where icons respectively indicating the positions of sensors in a predetermined area are displayed on a screen.

(9) A screen information processing program according to an embodiment of the present invention is a screen information processing program to be used in a screen information processing apparatus, the program causing a computer to execute the steps of: evaluating, when a plurality of icons respectively indicating positions of a plurality of sensors are to be displayed on a screen, an overlapping degree or crowdedness of the icons on the screen; and performing control of displaying, on the screen, an auxiliary icon which is a separate icon that groups the icons in accordance with a content of the evaluation of the overlapping degree or the crowdedness.

With this configuration, for example, in such a case where a plurality of sensors are arranged in a concentrated manner in a predetermined area, a plurality of icons that are concentrated on the screen indicating the predetermined area can be grouped to be displayed in the form of a separate icon. Accordingly, for example, it is possible to display icons so as not to overlap each other, and it is possible to secure to some extent the distance between icons. Thus, visibility can be improved in a configuration where icons respectively indicating the positions of sensors in a predetermined area are displayed on a screen.

Hereinafter, embodiments of the present invention will be described with reference to the drawings. In the drawings, the same or corresponding parts are denoted by the same reference signs, and description thereof is not repeated. At least some parts of the embodiments described below can be combined together as desired.

### First Embodiment

### Configuration and Basic Operation

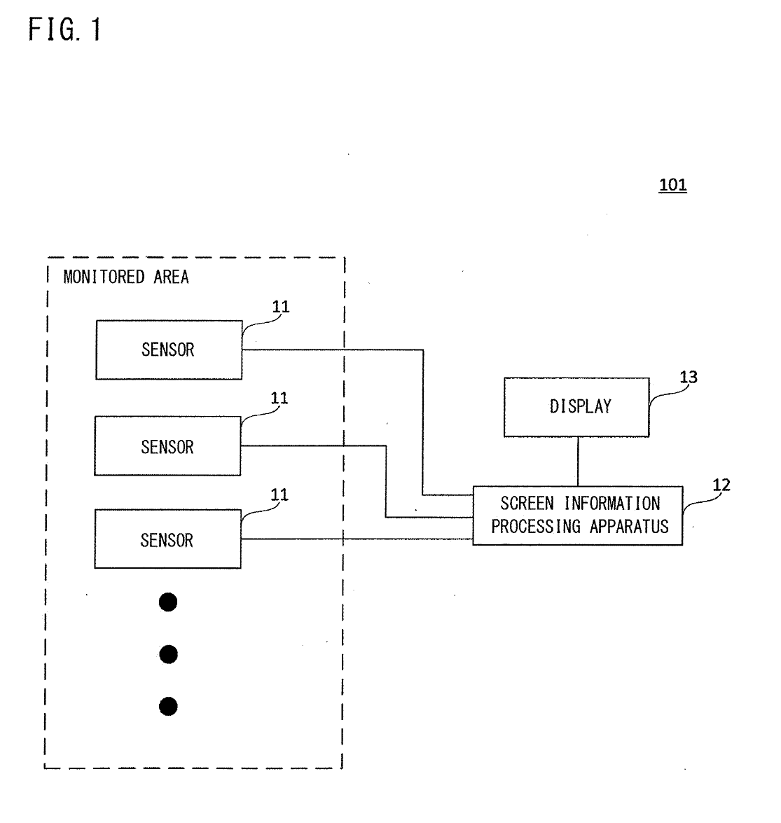

FIG. 1 shows a configuration of a monitoring system according to a first embodiment of the present invention.

With reference to FIG. 1, a monitoring system 101 includes a plurality of sensors 11, a screen information processing apparatus 12, and a display 13.

The sensors 11 are temperature sensors, humidity sensors, infrared sensor, and the like, and are arranged in monitoring target areas in factories, hospitals, shops, and the like. Such a monitoring target area may be set inside or outside a building.

In a case where the monitoring target area is a factory, the sensors 11 measure the temperature, the humidity, and the like in production facilities thereof, for example. Each sensor 11 transmits a measurement result and sensor information indicating its own ID to the screen information processing apparatus 12.

The screen information processing apparatus 12 is in wired or wireless connection with each sensor 11, and receives sensor information from each sensor 11. The screen information processing apparatus 12 can cause the display 13 to display the content of the received sensor information.

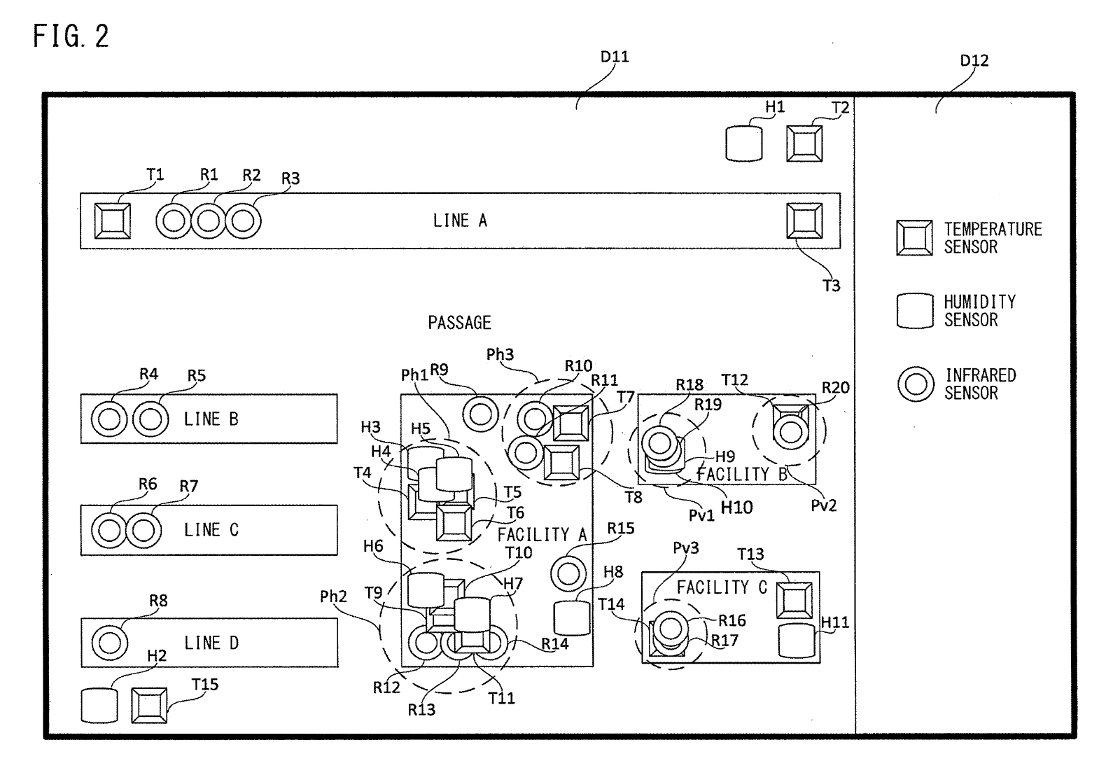

FIG. 2 shows one example of a screen displayed on the display in a comparative example of the monitoring system according to the first embodiment of the present invention.

With reference to FIG. 2, the screen includes a display area D11 and a display area D12. In the display area D11, a plan view of a factory being the monitoring target area is displayed. Specifically, the contours of a plurality of production facilities arranged in the monitoring target area, and icons (hereinafter, also referred to as sensor icons) respectively representing the sensors 11 are displayed in the display area D11.

In detail, in the display area D11, the contours of lines A to D being production lines, the contours of production facilities A to C, sensor icons T1 to T15 each representing a temperature sensor, sensor icons H1 to H11 each representing a humidity sensor, and sensor icons R1 to R20 each representing an infrared sensor are displayed. The sensor icons have different shapes in accordance with the types of the sensors 11, that is, depending on whether the sensor is a temperature sensor, a humidity sensor, or an infrared sensor.

In the display area D12, the correspondence relation between the types of the sensor icons displayed in the display area D11 and the types of the sensors 11 is shown.

By performing a click operation using a mouse, for example, onto a sensor icon displayed in the display area D11, a user can cause the content of the sensor information of the sensor 11 that corresponds to the sensor icon, to be displayed on the screen.

Here, in parts Ph1 to Ph3 and parts Pv1 to Pv3 shown with dashed lines in the display area D11, a plurality of sensor icons are displayed in an overlapping or crowded manner.

Specifically, in the places in the monitoring target area that respectively correspond to the parts Ph1 to Ph3 on the screen, the sensors 11 are arranged at the same position to some extent in the height direction and in a concentrated manner in the horizontal direction. Thus, in the parts Ph1 to Ph3 on the screen, the sensor icons are displayed in an overlapping or crowded manner.

In addition, in the places in the monitoring target area that respectively correspond to the parts Pv1 to Pv3 on the screen, the sensors 11 are arranged at substantially the same position in the horizontal direction and at different positions in the height direction. Therefore, in the parts Pv1 to Pv3 on the screen, the sensor icons are displayed in an overlapping or crowded manner.

When a plurality of sensor icons are displayed in an overlapping or crowded manner, it may be difficult for the user to correctly recognize the positional relationship among and the types of the sensor icons. Moreover, since the sensor icons are displayed in an overlapping or crowded manner, it may be difficult for the user to appropriately perform a click operation onto a desired sensor icon.

Therefore, in the monitoring system according to the first embodiment of the present invention, such a problem is solved by the process described below.

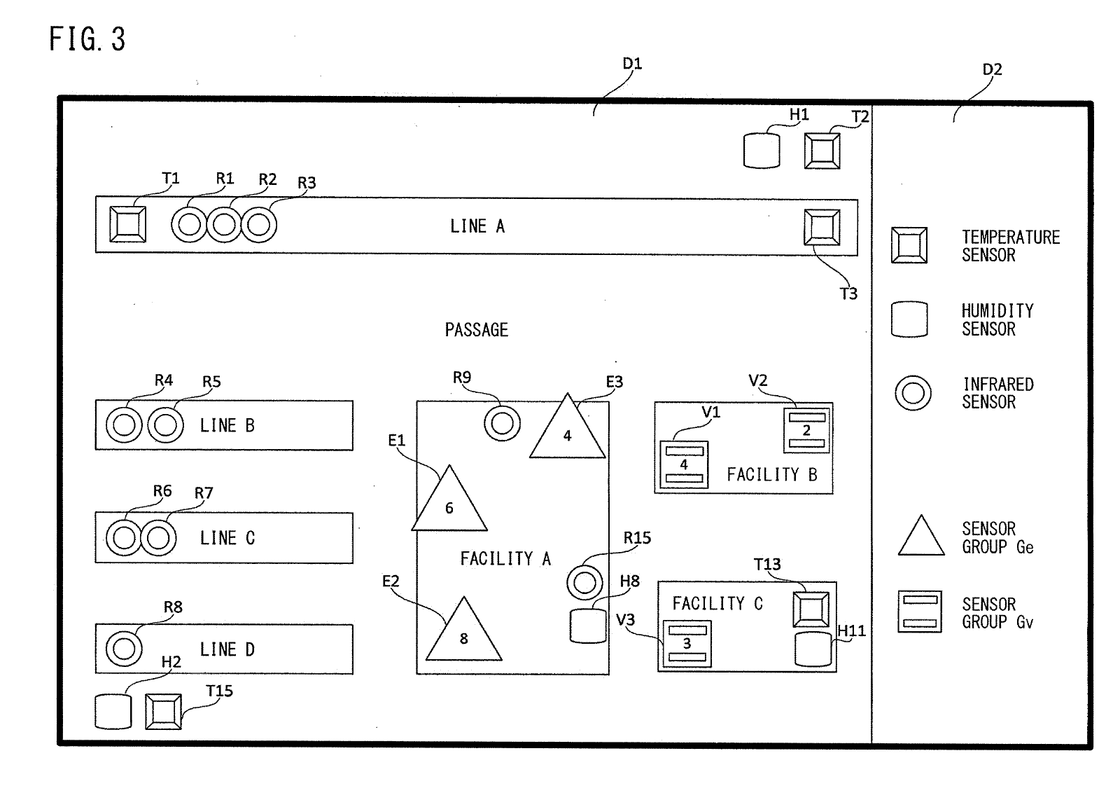

FIG. 3 shows one example of a screen displayed on the display in the monitoring system according to the first embodiment of the present invention.

With reference to FIG. 3, the screen includes a display area D1 and a display area D2. The contents displayed on the screen shown in FIG. 3 are the same as the contents displayed on the screen shown in FIG. 2 except the contents described below.

In the display area D1, when compared with the display area D11 shown in FIG. 2, auxiliary icons E1 E2, and E3 are displayed instead of the sensor icons included in the parts Ph1, Ph2, and Ph3, respectively.

Moreover, auxiliary icons V1, V2, and V3 are displayed instead of the sensor icons included in the parts Pv1, Pv2, and Pv3, respectively.

That is, the sensor icons included in the part Ph1, Ph2, Ph3 on the screen shown in FIG. 2 have been grouped into the auxiliary icon E1, E2, E3, respectively, on the screen shown in FIG. 3.

The sensor icons included in the part Pv1, Pv2, Pv3 on the screen shown in FIG. 2 have been grouped into the auxiliary icon V1, V2, V3, respectively, on the screen shown in FIG. 3.

Here, the sensor group that groups the sensors 11 that correspond to the sensor icons included in the part Ph1 will also be referred to as a sensor group Ge1, the sensor group that groups the sensors 11 that correspond to the sensor icons included in the part Ph2 will also be referred to as a sensor group Ge2, and the sensor group that groups the sensors 11 that correspond to the sensor icons included in the part Ph3 will also be referred to as a sensor group Ge3.

The auxiliary icons E1, E2, and E3 represent the sensor groups Ge1, Ge2, and Ge3, respectively. The sensors 11 included in each of the sensor groups Ge1 to Ge3 are arranged at the same position to some extent in the height direction and in a concentrated manner in the horizontal direction.

The sensor group that groups sensors 11 that correspond to the sensor icons included in the part Pv1 will also be referred to as a sensor group Gv1, the sensor group that groups the sensors 11 that correspond to the sensor icons included in the part Pv2 will also be referred to as a sensor group Gv2, and the sensor group that groups the sensors 11 that correspond to the sensor icons included in the part Pv3 will also be referred to as a sensor group Gv3.

The auxiliary icons V1, V2, and V3 represent the sensor groups Gv1, Gv2, and Gv3, respectively. The sensors 11 included in each of the sensor groups Gv1 to Gv3 are arranged at substantially the same position in the horizontal direction and at different positions in the height direction.

The sensor group Ge such as the sensor groups Ge1 to Ge3 and the sensor group Gv such as the sensor groups Gv1 to Gv3 are displayed in the form of auxiliary icons of different types so as to be distinguishable from each other. This allows the user to distinguish various types of positional relationship among sensors 11 that correspond to the auxiliary icons.

Each auxiliary icon has assigned thereto the number of sensor icons that has been grouped thereinto. Specifically, for example, the auxiliary icon E1 is an auxiliary icon that groups six sensor icons, i.e., sensor icons H3 to H5 and sensor icons T4 to T6. Thus, the auxiliary icon E1 is assigned with “6”.

The auxiliary icon E2 is an auxiliary icon that groups eight sensor icons, i.e., sensor icons H6 and H7, sensor icons T9 to T11, and sensor icons R12 to R14. Thus, the auxiliary icon E2 is assigned with “8”.

The auxiliary icon E3 is an auxiliary icon that groups four sensor icons, i.e., sensor icons T7 and T8 and sensor icons R10 and R11. Thus, the auxiliary icon E3 is assigned with “4”.

The auxiliary icon V1 is an auxiliary icon that groups four sensor icons, i.e., sensor icons R18 and R19 and sensor icons H9 and H10. Thus, the auxiliary icon V1 is assigned with “4”.

The auxiliary icon V2 is an auxiliary icon that groups two sensor icons, i.e., sensor icon T12 and sensor icon R20. Thus, the auxiliary icon V2 is assigned with “2”.

The auxiliary icon V3 is an auxiliary icon that groups three sensor icons, i.e., sensor icons R16 and R17 and sensor icon T14. Thus, the auxiliary icon V3 is assigned with “3”.

In the display area D2, when compared with the display area D12 shown in FIG. 2, the correspondence relation between the types of the auxiliary icons and the types of the sensor groups are further displayed.

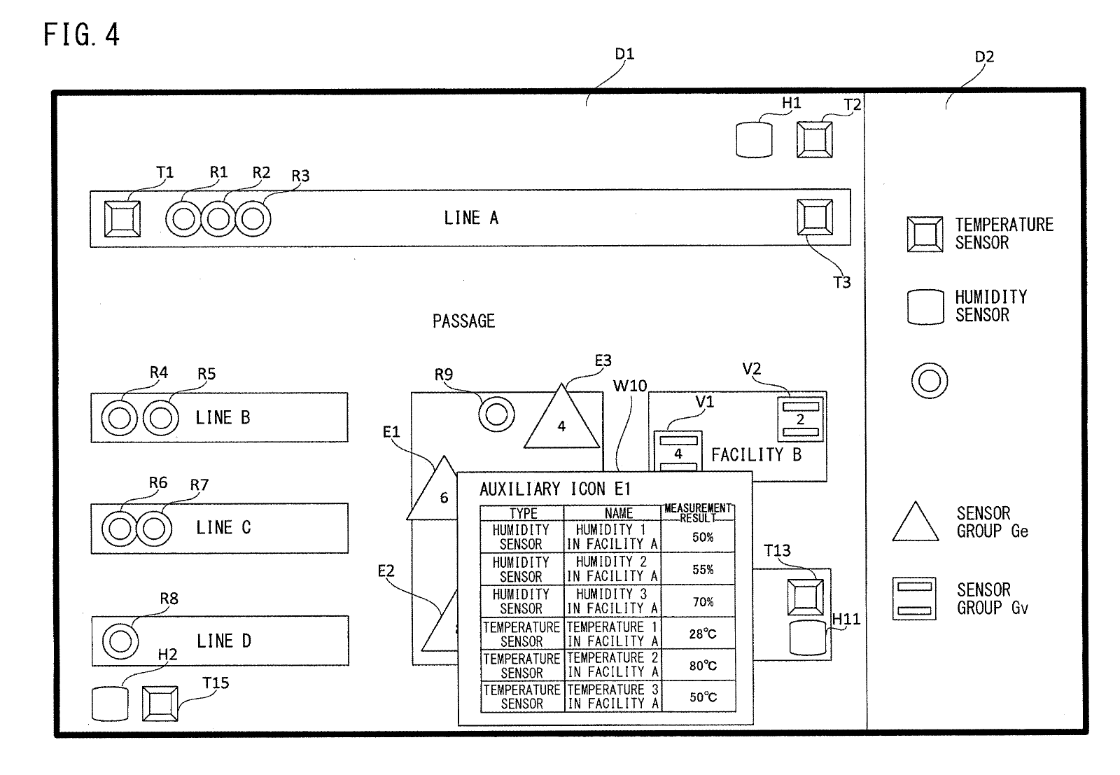

FIG. 4 shows another example of the screen displayed on the display in the monitoring system according to the first embodiment of the present invention.

With reference to FIG. 4, the screen includes the display area D1, the display area D2, and a display area W10. The display area W10 is displayed in such a manner as to overlap the display area D1.

The display area W10 is a window displayed as a result of the user performing an operation such as clicking onto the auxiliary icon E1, for example. In the display area W10, a list of information of the sensors 11 that correspond to the sensor icons grouped by the auxiliary icon E1, i.e., the sensors 11 that correspond to the auxiliary icon E1, is displayed.

Specifically, in the display area W10, “type”, “name”, and “measurement result” of each sensor 11 are displayed.

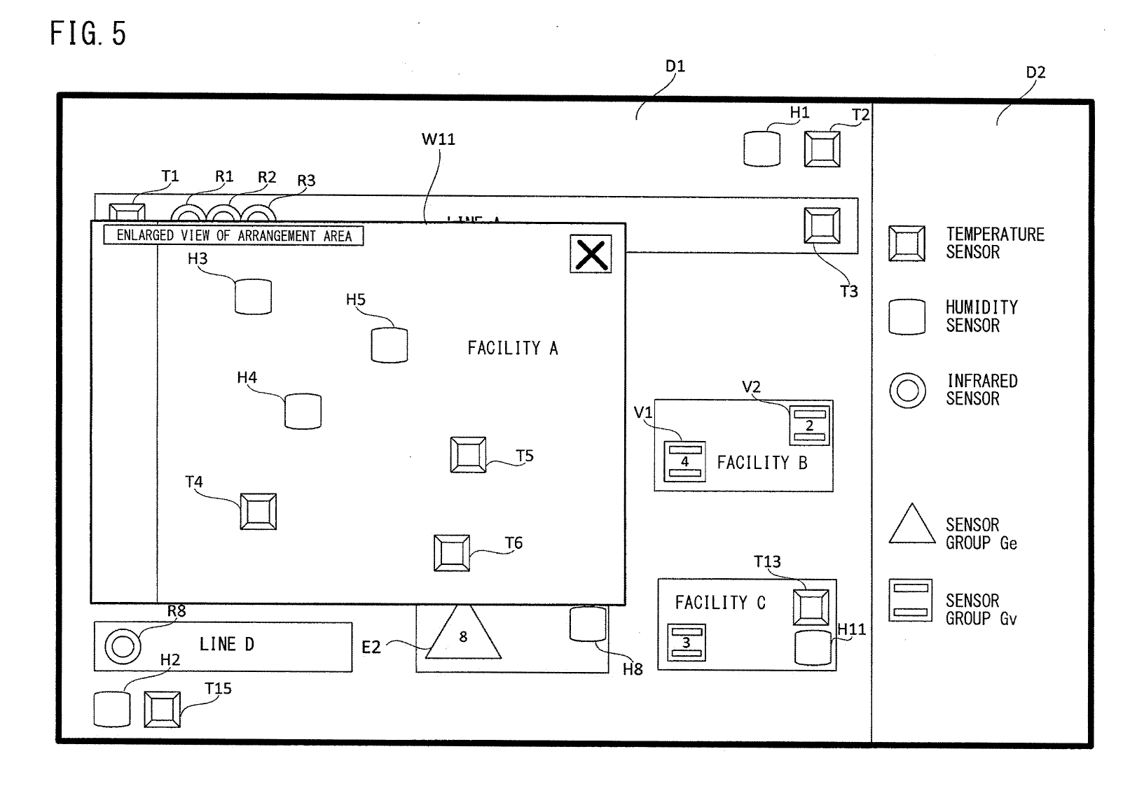

FIG. 5 shows another example of the screen displayed on the display in the monitoring system according to the first embodiment of the present invention.

With reference to FIG. 5, the screen includes the display area D1, the display area D2, and a display area W11. The display area W11 is displayed in such a manner as to overlap the display area D1.

The display area W11 is a window displayed as a result of the user performing a click operation or the like onto the auxiliary icon E1 on the screen shown in FIG. 3, for example. In the display area W11, an enlarged view of the arrangement area of the sensors 11 that correspond to the auxiliary icon E1 is displayed together with the sensor icons that correspond to the auxiliary icon E1.

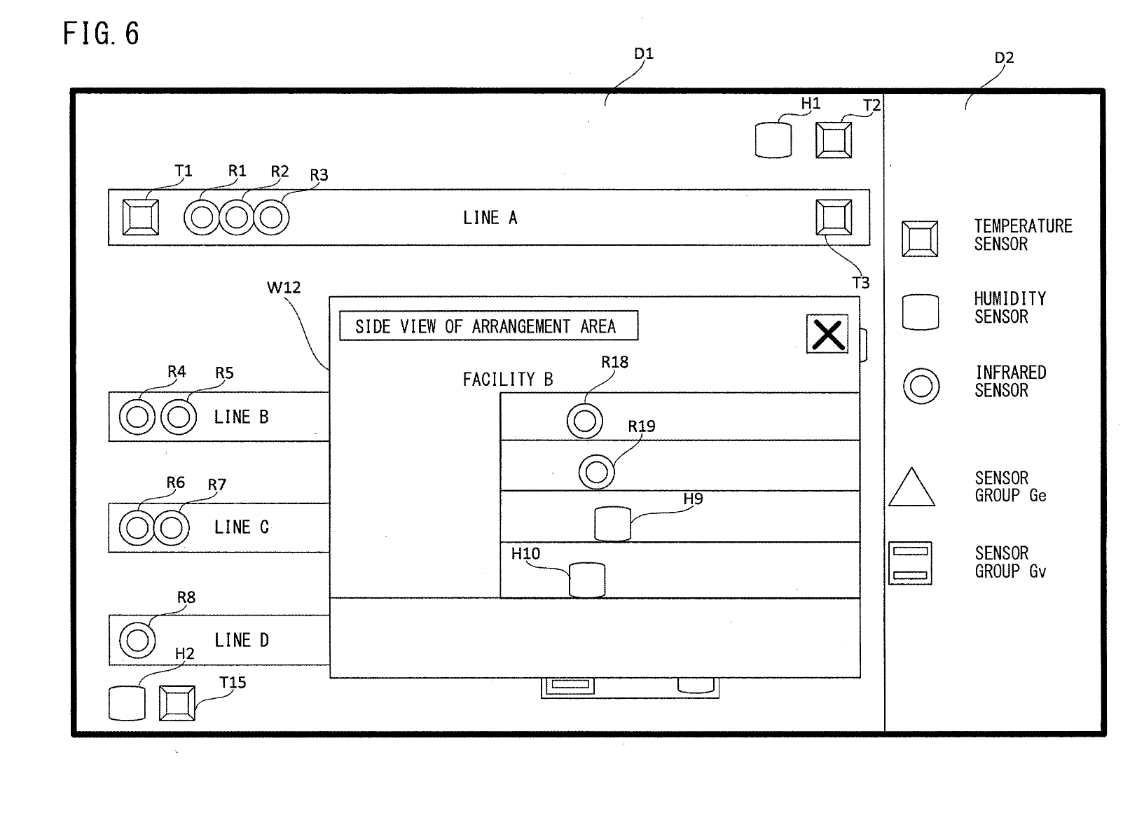

FIG. 6 shows another example of the screen displayed on the display in the monitoring system according to the first embodiment of the present invention.

With reference to FIG. 6, the screen includes the display area D1, the display area D2, and a display area W12. The display area W12 is displayed in such a manner as to overlap the display area D1.

The display area W12 is a window displayed as a result of the user performing a click operation or the like onto the auxiliary icon V1 on the screen shown in FIG. 3, for example. In the display area W12, a side view of the arrangement area of the sensors 11 that correspond to the auxiliary icon V1 is displayed together with the sensor icons that correspond to the auxiliary icon V1.

[Initial Setting for Screen Information Processing Apparatus]

Hereinafter, one example of initial setting for the screen information processing apparatus 12 will be described.

First, the user registers, in the screen information processing apparatus 12, production facilities arranged in the monitoring target area. Specifically, for example, the user draws on the screen with the mouse the contour of each production facility in a plan view, and inputs the height of each production facility to the screen information processing apparatus 12. The user can also input details of the shape of each production facility. Then, the user arranges sensor icons on the screen on which the production facilities are displayed.

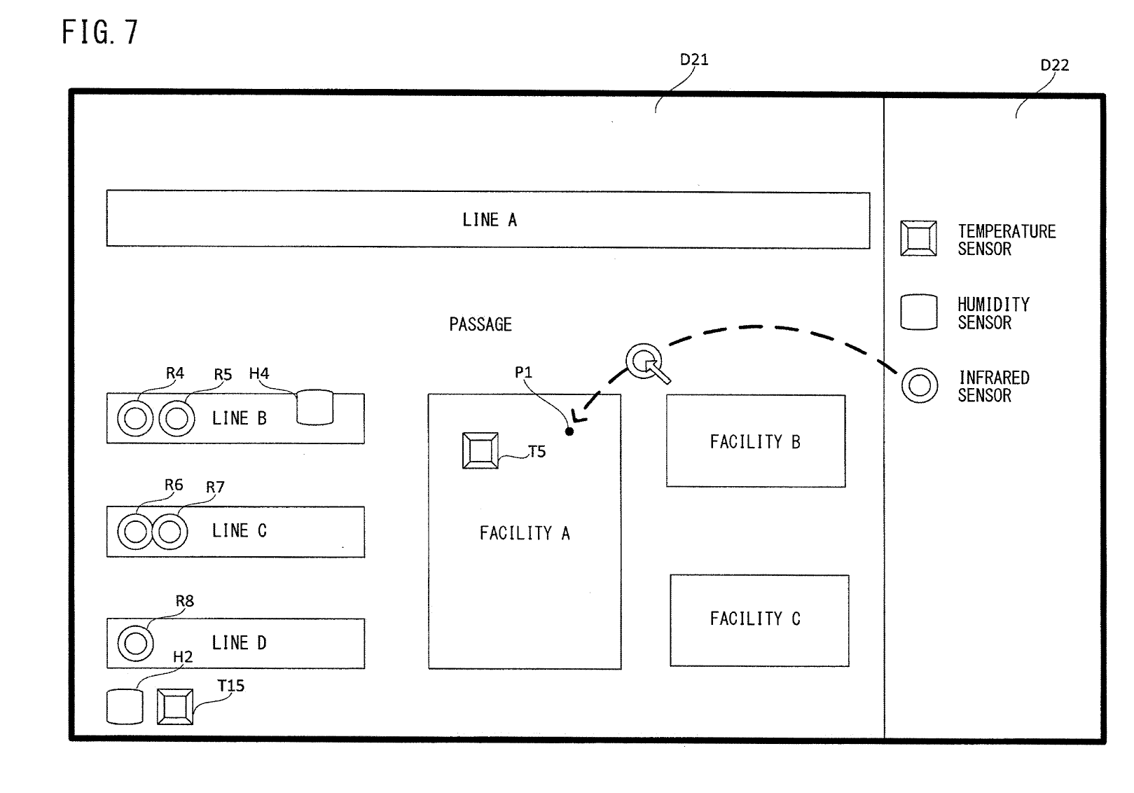

FIG. 7 shows another example of the screen displayed on the display in the monitoring system according to the first embodiment of the present invention.

FIG. 7 shows how the user arranges a sensor icon on the screen. With reference to FIG. 7, the screen includes a display area D21 and a display area D22. In the display area D21, the contours of the registered production facilities and the arranged sensor icons are displayed.

The user confirms the type and the place of each sensor 11 actually arranged in the monitoring target area, and arranges a sensor icon in accordance with the confirmed content. Specifically, for example, the user drags the sensor icon representing an infrared sensor and displayed in the display area D22, to a desired position P1 in the display area D21, and drops the sensor icon at the position P1. Accordingly, the user can arrange the sensor icon on the screen.

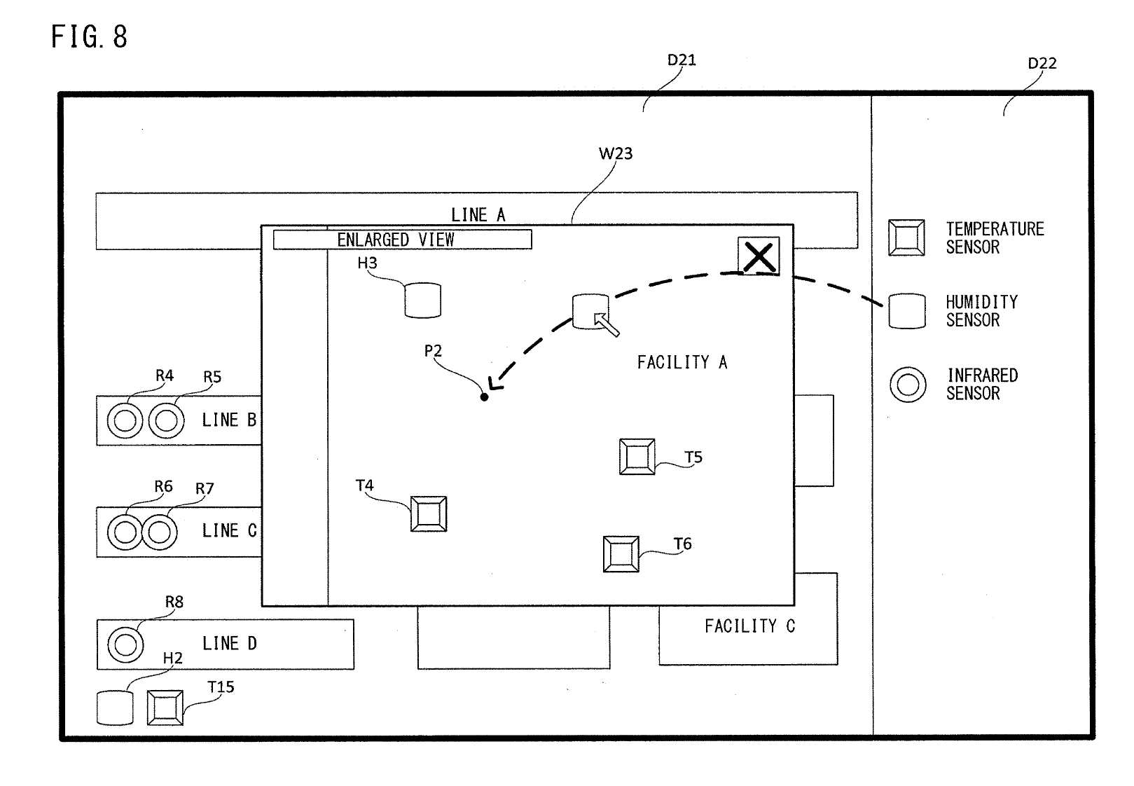

FIG. 8 shows another example of the screen displayed on the display in the monitoring system according to the first embodiment of the present invention.

FIG. 8 shows how the user arranges a sensor icon on the screen. With reference to FIG. 8, the screen includes the display area D21, the display area D22, and a display area W23. The display area W23 is displayed in such a manner as to overlap the display area D21.

For example, when the user is to arrange, on the screen, sensor icons that respectively correspond to the sensors 11 arranged in a concentrated manner, the user can cause an enlarged view of the area where the sensors 11 are arranged, to be displayed on the screen.

In the display area W23, an enlarged view of the area where the sensors 11 are arranged in a concentrated manner is displayed. For example, the user drags the sensor icon representing a humidity sensor and displayed on the display area D22, to a desired position P2 in the display area W23, and drops the sensor icon at the position P2. Accordingly, the user can arrange, on the screen, sensor icons that correspond to the sensors 11 arranged in a concentrated manner. The sensor icons arranged in the display area W23 are also reflected in the display area D21.

For example, after arranging a sensor icon on the screen, the user inputs, to the screen information processing apparatus 12, the name of and the arrangement height in the monitoring target area of the sensor 11 that correspond to the sensor icon.

In addition, the user associates the arranged sensor icon to the sensor 11 actually arranged in the monitoring target area.

Specifically, for example, upon receiving an operation performed by the user, the screen information processing apparatus 12 creates correspondence information indicating the correspondence relation between the sensor icon on the screen and the sensor 11.

Further, the screen information processing apparatus 12 creates sensor-settings information on the basis of: the correspondence information; the name and the arrangement height of each sensor 11 in the monitoring target area having been inputted by the user; and the type and the coordinates of each sensor icon arranged on the screen.

The sensor-settings information indicates the name, the type, the arrangement position and the arrangement height in the monitoring target area, and the corresponding sensor icon of each sensor 11.

Further, the screen information processing apparatus 12 creates facility registration information indicating the content of each production facility registered by the user. The facility registration information indicates the contour, the height, the arrangement position in the monitoring target area, and the like in a plan view of the production facility. It should be noted that the screen information processing apparatus 12 may be configured to obtain the facility registration information from another apparatus.

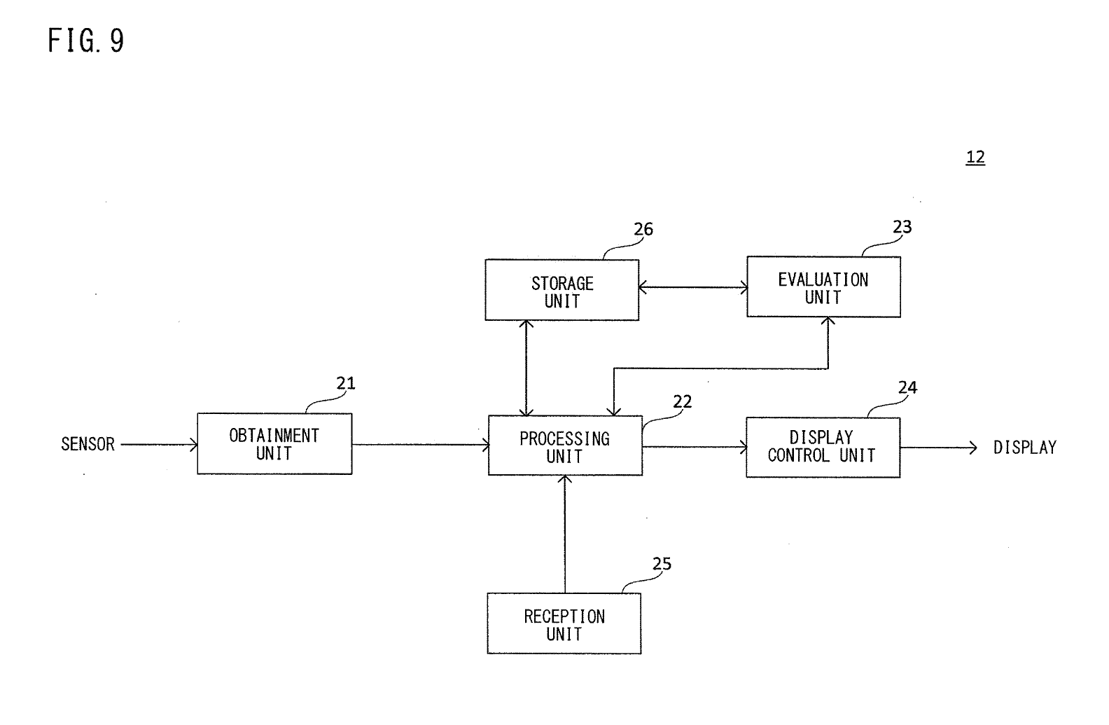

FIG. 9 shows a configuration of the screen information processing apparatus in the monitoring system according to the first embodiment of the present invention.

With reference to FIG. 9, the screen information processing apparatus 12 includes an obtainment unit 21, a processing unit 22, an evaluation unit 23, a display control unit 24, a reception unit 25, and a storage unit 26.

In the storage unit 26, the sensor-settings information and the facility registration information having been created on the basis of initial settings by the user are stored, for example.

The obtainment unit 21 periodically or non-periodically obtains sensor information indicating a measurement result from each sensor 11, and outputs the obtained sensor information to the processing unit 22. The processing unit 22 stores the sensor information received from the obtainment unit 21, into the storage unit 26.

When a plurality of sensor icons respectively indicating the positions of a plurality of sensors 11 are to be displayed on the screen, the evaluation unit 23 evaluates the overlapping degree or the crowdedness of the sensor icons on the screen.

Specifically, on the basis of the sensor-settings information and the facility registration information stored in the storage unit 26, the evaluation unit 23 creates provisional screen information which is the information of a screen on which the sensor icons have not yet been grouped. On the basis of the created provisional screen information, the evaluation unit 23 detects a part where sensor icons are displayed in an overlapping or crowded manner, as in the parts Ph1 to Ph3 and the parts Pv1 to Pv3 shown in FIG. 2, for example. Then, the evaluation unit 23 evaluates the overlapping degree or crowdedness of the sensor icons with respect to the detected part.

For example, the evaluation unit 23 evaluates the overlapping degree on the basis of the area of the overlapping parts among sensor icons on the screen indicated by the provisional screen information.

For example, the evaluation unit 23 evaluates the crowdedness of the sensor icons on the basis of the number of sensor icons per unit area on the screen indicated by the provisional screen information.

The evaluation unit 23 may indicate the evaluation content in terms of numerical values or levels, for example. The evaluation unit 23 outputs, to the processing unit 22, the provisional screen information and the evaluation content of the overlapping degree of the sensor icons, for example.

It should be noted that the evaluation unit 23 may simply evaluate the overlapping degree on the basis of the presence/absence of overlapping parts among the sensor icons.

The display control unit 24 performs control of displaying, on the screen, auxiliary icons each grouping their corresponding sensor icons in accordance with the content of the evaluation performed by the evaluation unit 23. In addition, for example, the display control unit 24 performs control of displaying auxiliary icons each assigned with the number of sensor icons that have been grouped thereinto.

In detail, for example, on the basis of the provisional screen information and the evaluation content received from the evaluation unit 23, the processing unit 22 determines whether to group sensor icons that are displayed in an overlapping or crowded manner into an auxiliary icon.

For example, when the value indicated by the evaluation content received from the evaluation unit 23 is greater than a predetermined threshold value, the processing unit 22 determines that the sensor icons having been the target of the evaluation are to be grouped into an auxiliary icon.

When having determined that the sensor icons are to be grouped into an auxiliary icon, the processing unit 22 determines which type of auxiliary icons is to be used, on the basis of the sensor-settings information stored in the storage unit 26.

Specifically, for the auxiliary icon, the processing unit 22 determines whether to use an auxiliary icon E such as the auxiliary icon E1 to E3, or whether to use an auxiliary icon V such as the auxiliary icon V1 to V3.

For example, in a case where the sensors 11 that correspond to the sensor icons that should be grouped into one auxiliary icon have substantially the same arrangement height, the processing unit 22 determines to use the auxiliary icon E as the auxiliary icon.

Alternatively, for example, in a case where the arrangement heights of the sensors 11 that correspond to the sensor icons that should be grouped into one auxiliary icon vary to some extent, the processing unit 22 determines to use the auxiliary icon V as the auxiliary icon.

The processing unit 22 creates, on the basis of the content of its own determination and the sensor-settings information and the facility registration information stored in the storage unit 26, screen information G which is the information of the screen shown in FIG. 3, for example. On the screen, each auxiliary icon E and each auxiliary icon V are assigned with the number of sensor icons that have been grouped thereinto.

The display control unit 24 transmits, to the display 13, the screen information G received from the processing unit 22, thereby displaying the auxiliary icons on the screen of the display 13.

For example, when a sensor icon has been designated on the screen through a click operation or the like, the display control unit 24 performs control of displaying, on the screen, sensor information that corresponds to the sensor icon.

In detail, the reception unit 25 receives an operation performed on the screen of the display 13 by the user. For example, when the user has performed a click operation C onto the sensor icon T1 on the screen shown in FIG. 3, the reception unit 25 receives the click operation C performed onto the sensor icon T1, and outputs operation information indicating the received content, to the processing unit 22.

Upon receiving the operation information from the reception unit 25, the processing unit 22 obtains sensor-settings information from the storage unit 26, for example. Then, on the basis of the obtained sensor-settings information, the processing unit 22 obtains from the storage unit 26 the sensor information of the sensor 11 that corresponds to the sensor icon T1, and outputs the obtained sensor information to the display control unit 24.

Upon receiving the sensor information from the processing unit 22, the display control unit 24 performs control of additionally displaying the content of the sensor information on the screen already displayed on the display 13.

[Display of List]

Furthermore, for example, when an auxiliary icon has been designated on the screen through a click operation or the like, the display control unit 24 performs control of displaying a list of information of the sensors that correspond to the auxiliary icon.

In detail, for example, when the user has performed a click operation C1, such as a single click onto the left button of the mouse, onto the auxiliary icon E1 on the screen shown in FIG. 3, the reception unit 25 receives the click operation C1 performed onto the auxiliary icon E1, and outputs operation information indicating the received content, to the processing unit 22.

Upon receiving the operation information from the reception unit 25, the processing unit 22 obtains, from the storage unit 26, sensor information and sensor-settings information from each of the sensors 11 that correspond to the auxiliary icon E1. Then, on the basis of the obtained sensor information and sensor-settings information, the processing unit 22 creates list information which is a list of information of the sensors 11 that correspond to the auxiliary icon E1. For example, the list information includes the type, the name, and the measurement result of each of the sensors 11 that correspond to the auxiliary icon E1. The processing unit 22 outputs the created list information to the display control unit 24.

Upon receiving the list information from the processing unit 22, the display control unit 24 performs control of additionally displaying the content of the list information on the screen already displayed on the display 13, for example.

Specifically, for example, upon receiving the list information from the processing unit 22, the display control unit 24 performs control of displaying the display area W10 shown in FIG. 4 in such a manner as to overlap the screen shown in FIG. 3.

[Enlarged Display]

Furthermore, for example, when an auxiliary icon has been designated on the screen through a click operation or the like, the display control unit 24 performs control of displaying an enlarged view of the arrangement area of the sensors 11 that correspond to the auxiliary icon, together with the sensor icons that correspond to the auxiliary icon.

In detail, for example, when the user has performed, onto the auxiliary icon E1 on the screen shown in FIG. 3, a click operation C2, which is an operation different from the click operation C1 and which is, for example, a double click onto the left button of the mouse, the reception unit 25 receives the click operation C2 performed onto the auxiliary icon E1, and outputs operation information indicating the received content, to the processing unit 22.

Upon receiving the operation information from the reception unit 25, the processing unit 22 obtains sensor-settings information and facility registration information from the storage unit 26. Then, on the basis of the obtained sensor-settings information and facility registration information, the processing unit 22 creates screen information Iz that indicates: an enlarged view of the arrangement area of the sensors 11 that correspond to the auxiliary icon E1; and the sensor icons that correspond to the auxiliary icon E1 and that are arranged in the enlarged view. The processing unit 22 outputs the created screen information Iz to the display control unit 24.

Specifically, upon receiving the screen information Iz from the processing unit 22, the display control unit 24 performs control of additionally displaying the screen information Iz on the screen already displayed on the display 13, for example.

More specifically, for example, upon receiving the screen information Iz, the display control unit 24 performs control of displaying the display area W11 shown in FIG. 5 in such a manner as to overlap the screen shown in FIG. 3.

[Display of Side View]

Furthermore, for example, when an auxiliary icon has been designated through a click operation or the like on the screen where a plan view of the arrangement area of the sensors 11 is displayed, the display control unit 24 performs control of displaying a side view of the arrangement area of the sensors 11 that correspond to the auxiliary icon, together with the sensor icons that correspond to the auxiliary icon.

In detail, for example, when the user has performed, onto the auxiliary icon V1 on the screen shown in FIG. 3 where a plan view of the monitoring target area is displayed, a click operation C3, which is an operation different from the click operation C1 and from the click operation C2 and which is, for example, a single click onto the right button of the mouse, the reception unit 25 receives the click operation C3 performed onto the auxiliary icon V1, and outputs operation information indicating the received content, to the processing unit 22.

Upon receiving the operation information from the reception unit 25, the processing unit 22 obtains sensor-settings information and facility registration information from the storage unit 26. Then, on the basis of the obtained sensor-settings information and facility registration information, the processing unit 22 creates screen information Is that indicates: a side view of the arrangement area of the sensors 11 that correspond to the auxiliary icon V1; and the sensor icons that correspond to the auxiliary icon V1 and that are arranged in the side view. The processing unit 22 outputs the created screen information Is to the display control unit 24.

Specifically, upon receiving the screen information Is from the processing unit 22, the display control unit 24 performs control of additionally displaying the screen information Is on the screen already displayed on the display 13, for example.

More specifically, for example, upon receiving the screen information Is, the display control unit 24 performs control of displaying the display area W12 shown in FIG. 6 in such a manner as to overlap the screen shown in FIG. 3.

[Operation]

Next, a displaying process performed by the screen information processing apparatus according to the first embodiment of the present invention will be described.

Each apparatus in the monitoring system 101 includes a computer, and an arithmetic processing unit such as a CPU in the computer reads out a program including a part or the entirety of steps in the following flow charts from a memory not shown, and executes the program. The programs for the plurality of apparatuses can each be installed from outside. The programs for the plurality of apparatuses are each distributed in a state of being stored in a storage medium.

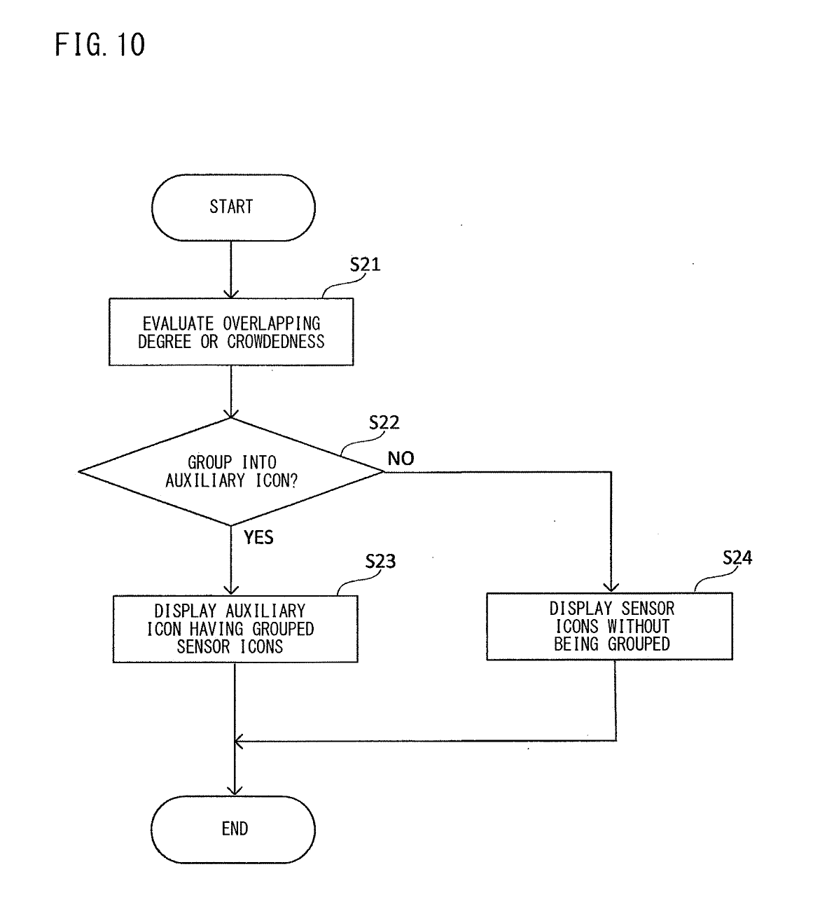

FIG. 10 is a flow chart showing one example of the displaying process to be performed by the screen information processing apparatus according to the first embodiment of the present invention.

With reference to FIG. 10, first, when a plurality of sensor icons respectively indicating the positions of a plurality of sensors 11 are to be displayed on the screen, the screen information processing apparatus 12 evaluates the overlapping degree or crowdedness of the sensor icons on the screen (step S21).

Specifically, with respect to sensor icons that are displayed in an overlapping or crowded manner in the case where the sensor icons are displayed without being grouped as on the screen shown in FIG. 2, the screen information processing apparatus 12 evaluates the overlapping degree or crowdedness.

Next, the screen information processing apparatus 12 performs control of displaying, on the screen, an auxiliary icon that groups its corresponding sensor icons in accordance with the content of the evaluation. Specifically, on the basis of the evaluation content of the overlapping degree or crowdedness, the screen information processing apparatus 12 determines whether to group sensor icons that are displayed in an overlapping or crowded manner into an auxiliary icon (step S22).

When having determined that sensor icons that are displayed in an overlapping or crowded manner are to be grouped into an auxiliary icon (YES in step S22), the screen information processing apparatus 12 creates screen information G being the information of the screen which is shown in FIG. 3, for example, and on which the sensor icons are grouped into an auxiliary icon on the basis of the sensor-settings information and facility registration information stored in the screen information processing apparatus 12, and performs control of displaying the created screen information G on the display 13 (step S23).

On the other hand, when having determined that sensor icons that are displayed in an overlapping or crowded manner are not to be grouped into an auxiliary icon on the basis of the evaluation content of the overlapping degree or crowdedness (NO in step S22), the screen information processing apparatus 12 creates screen information Q for not displaying any auxiliary icon, and performs control of displaying the screen information Q on the display 13 (step S24).

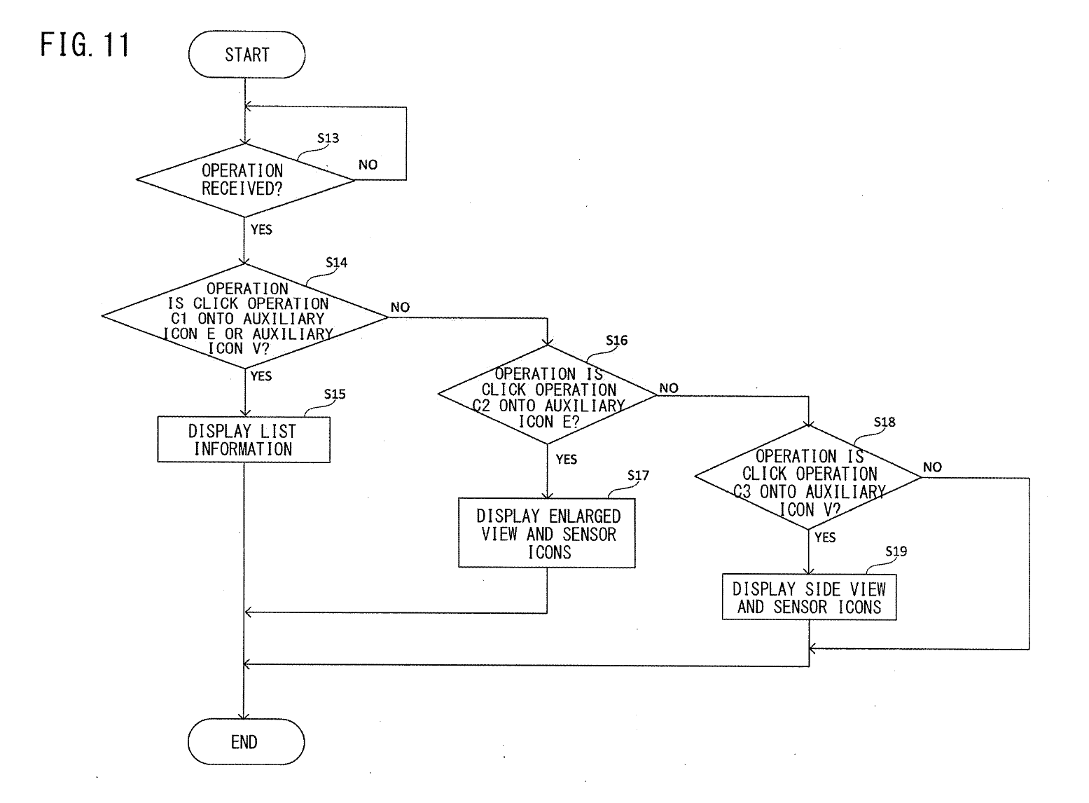

FIG. 11 is a flow chart showing another example of the displaying process performed by the screen information processing apparatus according to the first embodiment of the present invention.

With reference to FIG. 11, first, the screen information processing apparatus 12 waits until receiving an operation from the user (NO in step S13).

Next, when having received an operation from the user (YES in step S13), the screen information processing apparatus 12 confirms whether the operation by the user is a click operation C1 performed onto an auxiliary icon E or an auxiliary icon V (step S14).

Next, when the operation by the user is the click operation C1 performed onto an auxiliary icon E or an auxiliary icon V (YES in step S14), the screen information processing apparatus 12 performs control of displaying list information, i.e., a list of information of sensors that correspond to the auxiliary icon E or the auxiliary icon V onto which the click operation C1 has been performed (step S15).

Specifically, for example, the screen information processing apparatus 12 performs control of displaying the display area W10 shown in FIG. 4 in such a manner as to overlap the screen shown in FIG. 3.

When the operation by the user is not the click operation C1 performed onto an auxiliary icon E or an auxiliary icon V (NO in step S14), the screen information processing apparatus 12 confirms whether the operation is a click operation C2 performed onto an auxiliary icon E (step S16).

Next, when the operation by the user is the click operation C2 performed onto an auxiliary icon E (YES in step S16), the screen information processing apparatus 12 performs control of displaying an enlarged view of the arrangement area of the sensors 11 that correspond to the auxiliary icon E, together with the sensor icons that correspond to the auxiliary icon E (step S17).

Specifically, for example, the screen information processing apparatus 12 performs control of displaying the display area W11 shown in FIG. 5 in such a manner as to overlap the screen shown in FIG. 3.

When the operation by the user is not the click operation C2 performed onto an auxiliary icon E (NO in step S16), the screen information processing apparatus 12 confirms whether the operation is a click operation C3 performed onto an auxiliary icon V (step S18).

Next, when the operation by the user is the click operation C3 performed onto an auxiliary icon V (YES in step S18), the screen information processing apparatus 12 performs control of displaying a side view of the arrangement area of the sensors 11 that correspond to the auxiliary icon V, together with the sensor icons that correspond to the auxiliary icon V (step S19).

Specifically, for example, the display control unit 24 performs control of displaying the display area W12 shown in FIG. 6 in such a manner as to overlap the screen shown in FIG. 3.

It should be noted that, in the screen information processing apparatus 12 according to the first embodiment of the present invention, the display control unit 24 is configured to perform, upon receiving the list information from the processing unit 22, control of additionally displaying the content of the list information on the screen already displayed on the display 13, for example. However, the present invention is not limited thereto.

For example, the display control unit 24 may be configured to, upon receiving the list information from the processing unit 22, perform control of switching the screen currently displayed on the display 13 to a new screen on which the list information is displayed.

In the screen information processing apparatus 12 according to the first embodiment of the present invention, the display control unit 24 is configured to, upon receiving the screen information Iz from the processing unit 22, perform control of additionally displaying the screen information Iz on the screen already displayed on the display 13. However, the present invention is not limited thereto.

For example, the display control unit 24 may be configured to, upon receiving the screen information Iz from the processing unit 22, perform control of switching the screen currently displayed on the display 13 to a new screen on which the screen information Iz is displayed.

In the monitoring system 101 according to the first embodiment of the present invention, the display control unit 24 is configured to, upon receiving the screen information Is from the processing unit 22, perform control of additionally displaying the screen information Is on the screen already displayed on the display 13. However, the present invention is not limited thereto.

For example, the display control unit 24 may be configured to, upon receiving the screen information Is from the processing unit 22, perform control of switching the screen currently displayed on the display 13 to a new screen on which the screen information Is is displayed.

Moreover, the screen information processing apparatus 12 according to the first embodiment of the present invention is configured to receive designation of a sensor icon and an auxiliary icon through a click operation, but the present invention is not limited thereto. For example, in a case where the display 13 includes a touch panel, the screen information processing apparatus 12 may be configured to receive designation of a sensor icon and an auxiliary icon through a tapping operation performed onto the display 13 by the user.

Moreover, the screen information processing apparatus 12 according to the first embodiment of the present invention is configured to create list information upon receiving a click operation or the like performed by the user. However, the present invention is not limited thereto. For example, the list information may be created by another apparatus, or may be stored in advance in a memory.

Meanwhile, in order to monitor the state of a monitoring target in a predetermined area, there are cases where the arrangement of sensors in the predetermined area is displayed on a screen. In such a case, if a plurality of sensors are arranged in a concentrated manner, a plurality of icons respectively representing the plurality of sensors overlap each other or are crowded on the screen, and thus, visibility is reduced.

In contrast to this, in the screen information processing apparatus according to the first embodiment of the present invention, when a plurality of sensor icons respectively indicating the positions of a plurality of sensors 11 are to be displayed on the screen, the evaluation unit 23 evaluates the overlapping degree or crowdedness of the sensor icons on the screen. The display control unit 24 performs control of displaying, on the screen, auxiliary icons which are separate icons that each group their corresponding sensor icons in accordance with the content of the evaluation performed by the evaluation unit 23.

With this configuration, for example, in such a case where a plurality of sensors 11 are arranged in a concentrated manner in the predetermined area, a plurality of sensor icons that are concentrated on the screen indicating the predetermined area can be grouped to be displayed in the form of a separate icon. Accordingly, for example, it is possible to display sensor icons so as not to overlap each other, and it is possible to secure to some extent the distance between sensor icons.

Therefore, in the screen information processing apparatus according to the first embodiment of the present invention, visibility can be improved in a configuration where icons respectively indicating the positions of sensors in a predetermined area are displayed on a screen.

In the screen information processing apparatus according to the first embodiment of the present invention, the obtainment unit 21 obtains sensor information indicating the measurement result of each sensor 11. When a sensor icon has been designated on the screen, the display control unit 24 performs control of displaying, on the screen, sensor information that corresponds to the sensor icon.

With this configuration, the user can easily confirm the sensor information of a desired sensor 11.

In the screen information processing apparatus according to the first embodiment of the present invention, the display control unit 24 performs control of displaying auxiliary icons each assigned with the number of sensor icons that have been grouped thereinto.

With this configuration, the user can recognize at a glance how many sensor icons have been grouped into each auxiliary icon, without performing a special operation.

In the screen information processing apparatus according to the first embodiment of the present invention, when an auxiliary icon has been designated on the screen, the display control unit 24 performs control of displaying an enlarged view of the arrangement area of the sensors 11 that correspond to the auxiliary icon, together with the sensor icons that correspond to the auxiliary icon.

With this configuration, the user can confirm, on the enlarged view, the sensor icons that have been grouped into the auxiliary icon, and thus, can recognize the specific position of each sensor icon.

In the screen information processing apparatus according to the first embodiment of the present invention, when an auxiliary icon has been designated on the screen on which a plan view of the arrangement area of the sensors 11 is displayed, the display control unit 24 performs control of displaying a side view of the arrangement area of the sensors 11 that correspond to the auxiliary icon, together with the sensor icons that correspond to the auxiliary icon.

With this configuration, for example, in a case where sensor icons that correspond to a plurality of sensors 11 arranged at substantially the same position in the horizontal direction and at different positions in the height direction are grouped into an auxiliary icon, the user can confirm, on the side view, the sensor icons that have been grouped into the auxiliary icon. Thus, the use can recognize the specific position of each sensor icon.

In the screen information processing apparatus according to the first embodiment of the present invention, when an auxiliary icon has been designated on the screen, the display control unit 24 performs control of displaying a list of information of the sensors 11 that correspond to the auxiliary icon.

With this configuration, the user can view the listed information regarding the plurality of sensors 11 that correspond to the auxiliary icon.

Next, another embodiment of the present invention will be described with reference to the drawings. It should be noted that, in the drawings, the same or corresponding parts are denoted by the same reference signs, and description thereof is not repeated.

### Second Embodiment

This embodiment of the present invention relates to a monitoring system in which the contents displayed on the screen are different, compared with the monitoring system according to the first embodiment.

[Configuration and Basic Operation]

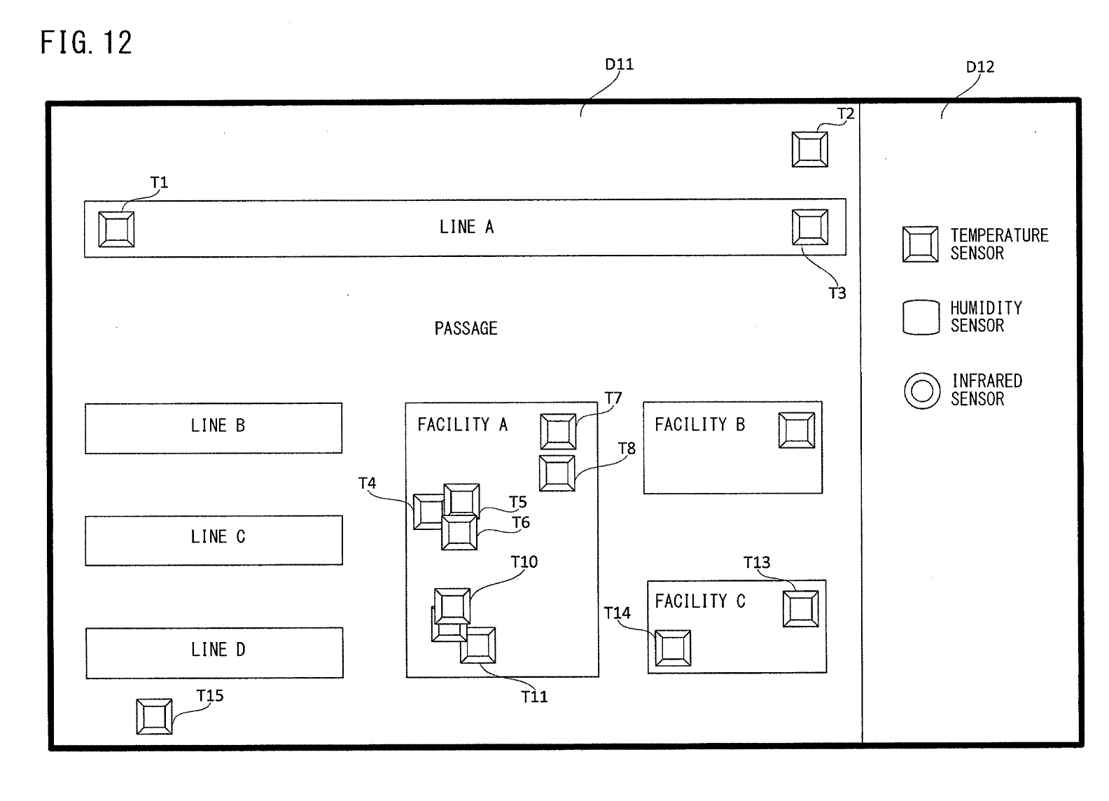

FIG. 12 shows one example of a screen displayed on the display in the monitoring system according to a second embodiment of the present invention.

With reference to FIG. 12, the screen includes the display area D11 and the display area D12. In the display area D11, a plan view of a factory being the monitoring target area is displayed. Specifically, in the display area D31, the contours of a plurality of production facilities arranged in the monitoring target area, and sensor icons are displayed.

In detail, in the display area D11, the contours of the lines A to D being the production lines, the contours of the production facilities A to C, and the sensor icons T1 to T15 each representing a temperature sensor are displayed.

In the display area D12, the correspondence relation between the types of the sensor icons displayed in the display area D11 and the types of the sensors 11 is shown.

The screen shown in FIG. 12 is a screen displayed as a result of the user performing a click operation C10, such as a double click onto the right button of the mouse, onto the sensor icon representing a temperature sensor among the sensor icons displayed in the display area D12 on the screen shown in FIG. 2, for example.

When the user has performed the click operation C10 onto any one of the sensor icons displayed in the display area D12, sensor icons of the types that are different from the type of the sensor icon on which the click operation C10 has been performed are not displayed in the display area D11. In other words, in the display area D11, the sensor icons that correspond to the designated type of sensor 11 are selectively displayed.

Here, since the click operation C10 has been performed onto the sensor icon representing a temperature sensor displayed in the display area D12, the sensor icons T1 to T15 which are each a sensor icon representing a temperature sensor are displayed in the display area D11, and the sensor icons H1 to H11 each representing a humidity sensor and the sensor icons R1 to R20 each representing an infrared sensor are not displayed.

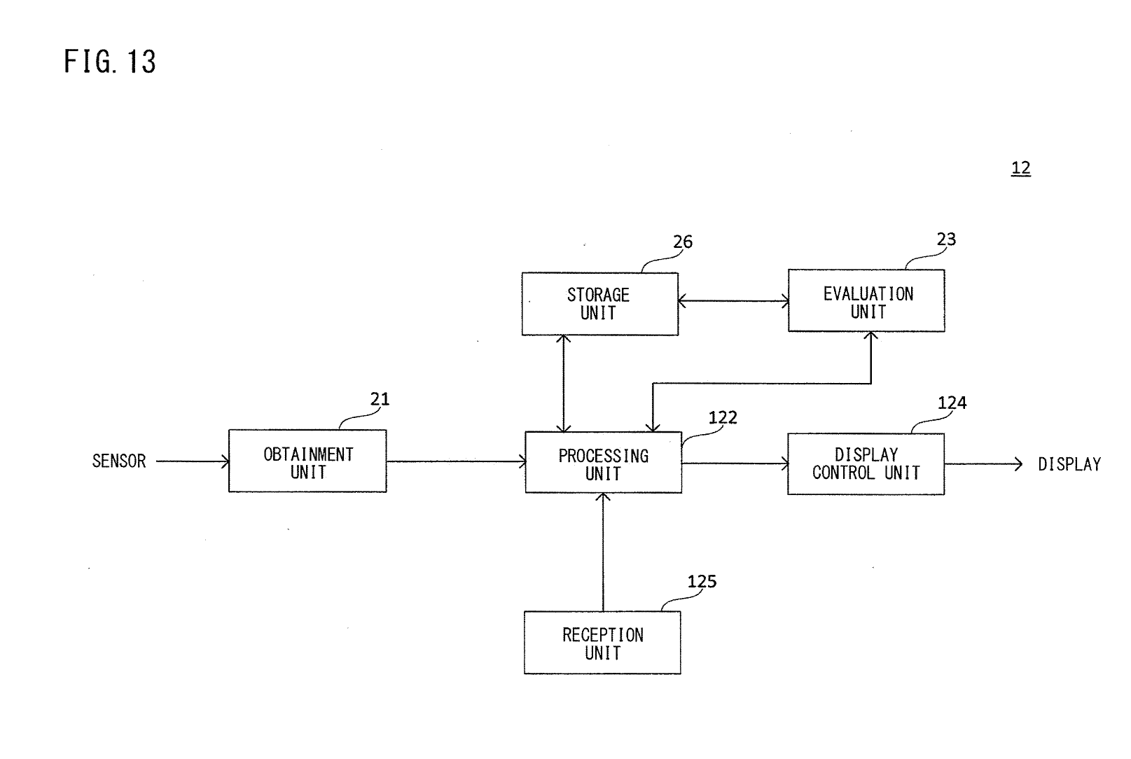

FIG. 13 shows a configuration of the screen information processing apparatus according to the second embodiment of the present invention.

With reference to FIG. 13, the screen information processing apparatus 12 includes the obtainment unit 21, the evaluation unit 23, the storage unit 26, a processing unit 122, a display control unit 124, and a reception unit 125.

That is, compared with the screen information processing apparatus 12 according to the first embodiment of the present invention, the screen information processing apparatus 12 includes the processing unit 122, the display control unit 124, and the reception unit 125, which are capable of further performing operations described below, instead of the processing unit 22, the display control unit 24, and the reception unit 25.

The display control unit 124 performs control of selectively displaying sensor icons that correspond to the sensor 11 of the type designated on the screen.

In detail, for example, on the screen shown in FIG. 2, when the user has performed the click operation C10 onto the sensor icon representing a temperature sensor among the sensor icons displayed in the display area D12, the reception unit 125 receives the click operation C10 performed onto the sensor icon, and outputs operation information indicating the received content, to the processing unit 122.

Upon receiving the operation information from the reception unit 25, the processing unit 122 creates screen information G2 being the information of the screen shown in FIG. 12, for example.

Specifically, upon receiving the operation information, the processing unit 122 creates the screen information G2 being the information of the screen on which, among the plurality of types of sensor icons displayed in the display area D11 on the current screen, sensor icons of the same type as the sensor icon on which the click operation C10 has been performed are selectively displayed. Then, the processing unit 122 outputs the created screen information G2, to the display control unit 124.

The display control unit 124 transmits, to the display 13, the screen information G2 received from the processing unit 122, thereby performing control of selectively displaying the sensor icons each representing a temperature sensor.

It should be noted that, in the screen information processing apparatus 12 according to the second embodiment of the present invention, the display control unit 124 is configured to perform control of selectively displaying the sensor icons that correspond to the sensor 11 of the type designated on the screen, but the present invention is not limited thereto. For example, the display control unit 124 may be configured to perform control of selectively not displaying the sensor icons that correspond to the sensor 11 of the type designated on the screen.

Specifically, for example, on the screen shown in FIG. 2, when the sensor icon representing a temperature sensor displayed in D12 has been designated, the display control unit 124 may not display in the display area D11 the sensor icons T1 to T15 which each are a sensor icon representing a temperature sensor, but may perform control of displaying the sensor icons H1 to H11 each representing a humidity sensor and the sensor icons R1 to R20 each representing an infrared sensor.

As described above, in the screen information processing apparatus according to the second embodiment of the present invention, the display control unit 24 performs control of selectively displaying or selectively not displaying the sensor icons that correspond to the sensor 11 of the type designated on the screen.

With this configuration, for example, in a case where a plurality of types of sensor icons overlap each other or are crowded, the types of the sensor icons to be displayed on the screen can be limited, and thus, visibility can be further increased.

The other configuration and operations are the same as those in the screen information processing apparatus according to the first embodiment, and thus, detailed description thereof is not repeated here.

Next, another embodiment of the present invention will be described with reference to the drawings. In the drawings, the same or corresponding parts are denoted by the same reference signs, and description thereof is not repeated.

### Third Embodiment

This embodiment of the present invention relates to a monitoring system in which a single type of auxiliary icon is displayed on the screen, compared with the monitoring system according to the first embodiment.

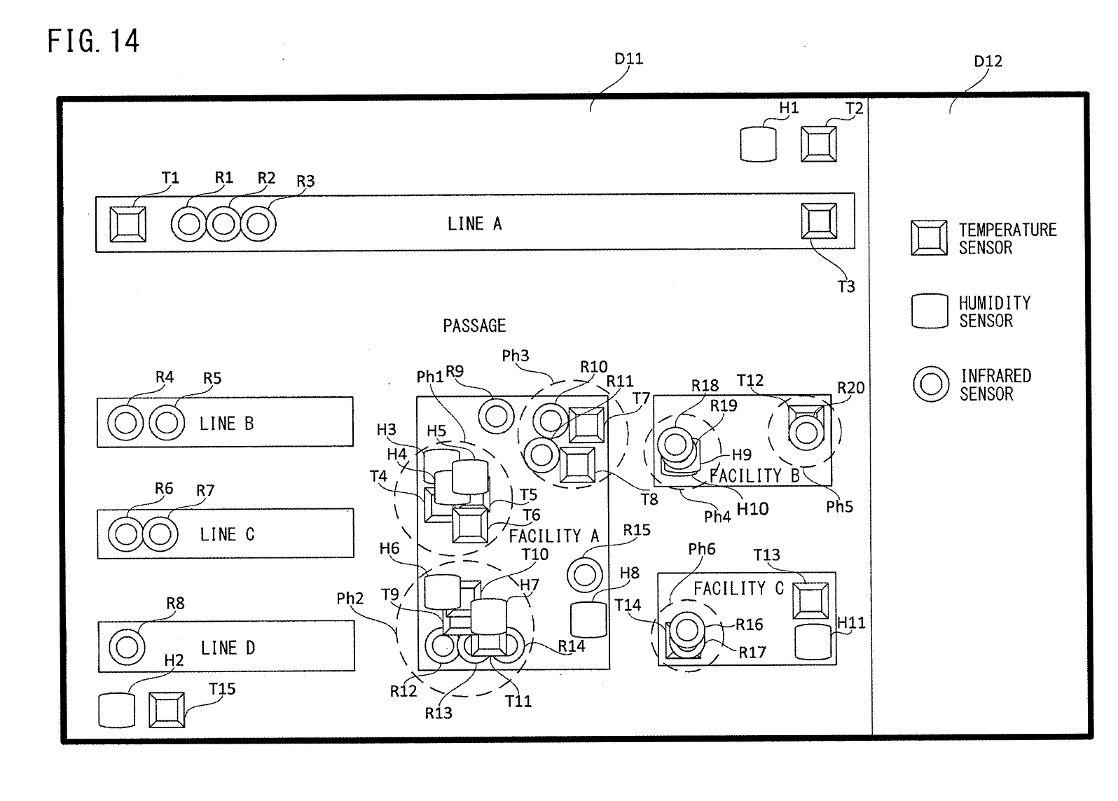

FIG. 14 shows one example of a screen displayed on the display in a comparative example of the monitoring system according to a third embodiment of the present invention.

With reference to FIG. 14, the screen includes the display area D11 and the display area D12. In the display area D11, a plan view of a factory being the monitoring target area is displayed. Specifically, in the display area D11, the contours of a plurality of production facilities arranged in the monitoring target area, and sensor icons respectively representing the sensors 11 are displayed.

In detail, in the display area D11, the contours of the lines A to D being the production lines, the contours of the production facilities A to C, the sensor icons T1 to T15 each representing a temperature sensor, the sensor icons H1 to H11 each representing a humidity sensor, and the sensor icons R1 to R20 each representing an infrared sensor are displayed. The sensor icons have different shapes in accordance with the types of the sensors 11, that is, depending on whether the sensor is a temperature sensor, a humidity sensor, or an infrared sensor.

In the display area D12, the correspondence relation between the types of the sensor icons displayed in the display area D11 and the types of the sensors 11 is shown.

By performing a click operation using the mouse, for example, onto a sensor icon displayed in the display area D11, the user can cause the content of the sensor information of the sensor 11 that corresponds to the sensor icon, to be displayed on the screen.

Here, in the parts Ph1 to Ph6 shown with dashed lines in the display area D11, a plurality of sensor icons are displayed in an overlapping or crowded manner.

Specifically, in the places in the monitoring target area that respectively correspond to the parts Ph1 to Ph3 on the screen, the sensors 11 are arranged in a concentrated manner when viewed from above. Therefore, in the parts Ph1 to Ph6 on the screen, the sensor icons are displayed in an overlapping or crowded manner. It should be noted that the sensors 11 may be arranged at the same position to some extent in the height direction, and may be arranged at different positions in the height direction.

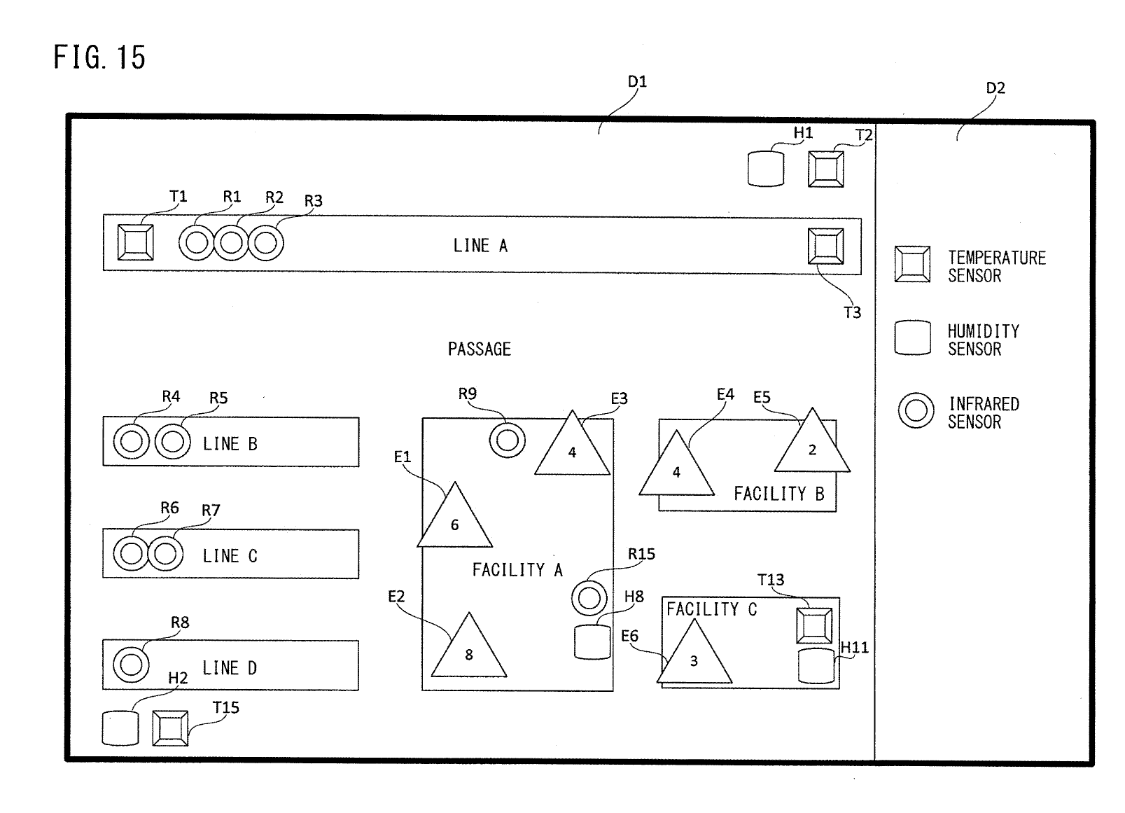

FIG. 15 shows one example of a screen displayed on the display in the monitoring system according to the third embodiment of the present invention.

With reference to FIG. 15, the screen includes the display area D1 and the display area D2. The contents displayed on the screen shown in FIG. 15 are the same as the contents displayed on the screen shown in FIG. 14 except the contents described below.

In the display area D1, when compared with the display area D11 shown in FIG. 14, the auxiliary icons E1, E2, E3, E4, E5 and E6 are displayed instead of the sensor icons included in the parts Ph1, Ph2, Ph3, Ph4, Ph5, and Ph6.

The sensors 11 that correspond to the auxiliary icons E1, E2, E3, E4, E5, and E6, are arranged in a concentrated manner when viewed from above.

Each auxiliary icon E is assigned with the number of sensor icons that have been grouped thereinto. Specifically, for example, the auxiliary icon E1 is an auxiliary icon that groups six sensor icons, i.e., sensor icons H3 to H5 and sensor icons T4 to T6. Thus, the auxiliary icon E1 is assigned with “6”.

The auxiliary icon E2 is an auxiliary icon that groups eight sensor icons, i.e., sensor icons H6 and H7, sensor icons T9 to T11, and sensor icons R12 to R14. Thus, the auxiliary icon E2 is assigned with “8”.

The auxiliary icon E3 is an auxiliary icon that groups four sensor icons, i.e., sensor icons T7 and T8 and sensor icons R10 and R11. Thus, the auxiliary icon E3 is assigned with “4”.

The auxiliary icon E4 is an auxiliary icon that groups four sensor icons, i.e., sensor icons R18 and 19 and sensor icons H9 and H10. Thus, the auxiliary icon E4 is assigned with “4”.

The auxiliary icon E5 is an auxiliary icon that groups two sensor icons, i.e., sensor icon T12 and sensor icon R20. Thus, the auxiliary icon E5 is assigned with “2”.

The auxiliary icon E6 is an auxiliary icon that groups three sensor icons, i.e., sensor icons R16 and 17 and sensor icon T14. Thus, the auxiliary icon E6 is assigned with “3”.

For example, when the user has performed a click operation C1, such as a single click onto the left button of the mouse, onto an auxiliary icon E, the screen information processing apparatus 12 performs control of displaying list information, i.e., a list of information of sensors that correspond to the auxiliary icon E.

Specifically, for example, the screen information processing apparatus 12 performs control of displaying the display area W10 shown in FIG. 4 in such a manner as to overlap the screen shown in FIG. 15.

For example, when the user has performed onto an auxiliary icon E a click operation C2, which is an operation different from the click operation C1 and which is, for example, a double click onto the left button of the mouse, the screen information processing apparatus 12 performs control of displaying an enlarged view of the arrangement area of the sensors 11 that correspond to the auxiliary icon E, together with the sensor icons that correspond to the auxiliary icon E.

Specifically, for example, the screen information processing apparatus 12 performs control of displaying the display area W11 shown in FIG. 5 in such a manner as to overlap the screen shown in FIG. 15.

For example, when the user has performed onto an auxiliary icon E a click operation C3, which is an operation different from the click operation C1 and from the click operation C2 and which is, for example, a single click onto the right button of the mouse, the screen information processing apparatus 12 performs control of displaying a side view of the arrangement area of the sensors 11 that correspond to the auxiliary icon E, together with the sensor icons that correspond to the auxiliary icon E.

Specifically, for example, the screen information processing apparatus 12 performs control of displaying the display area W12 shown in FIG. 6 in such a manner as to overlap the screen shown in FIG. 15.

The other configuration and operations are the same as those in the screen information processing apparatus according to the first embodiment, and thus, detailed description thereof is not repeated here.

It should be understood that the embodiments above are merely illustrative and not restrictive in all aspects. The scope of the present invention is defined by the scope of the claims rather than the above description, and is intended to include meaning equivalent to the scope of the claims and all modifications within the scope.

The above description includes the features in the additional notes below.

[Additional Notes]

A screen information processing apparatus comprising:

an evaluation unit configured to, when a plurality of icons respectively indicating positions of a plurality of sensors are to be displayed on a screen, evaluate an overlapping degree or crowdedness of the icons on the screen; and

a display control unit configured to perform control of displaying, on the screen, an auxiliary icon which is a separate icon that groups the icons in accordance with a content of the evaluation performed by the evaluation unit, wherein

arrangement of the icons on the screen indicates arrangement of the sensors that correspond to the icons in a predetermined area,

the display control unit is capable of performing control of displaying a plurality of types of auxiliary icons,

the display control unit performs control of displaying auxiliary icons of different types depending on a case of displaying an auxiliary icon that groups the icons that correspond to the sensors arranged at substantially the same position in a height direction and in a concentrated manner in a horizontal direction, and on a case of displaying an auxiliary icon that groups the icons that correspond to the sensors arranged at substantially the same position in the horizontal direction and at different positions in the height direction.

### REFERENCE SIGNS LIST

11 sensor
12 screen information processing apparatus
13 display
21 obtainment unit
22 processing unit
23 evaluation unit
24 display control unit
25 reception unit
26 storage unit
101 monitoring system
122 processing unit
124 display control unit
125 reception unit
D1, D2, D11, D12, D21, D22, D31, W10 to W12, W23 display area
E1 to E6, V1 to V3 auxiliary icon
T1 to T15, H1 to H11, R1 to R20 sensor icon

1. A screen information processing apparatus comprising:
an evaluation unit configured to, when a plurality of icons respectively indicating positions of a plurality of sensors are to be displayed on a screen, evaluate an overlapping degree or crowdedness of the icons on the screen; and
a display control unit configured to perform control of displaying, on the screen, an auxiliary icon which is a separate icon that groups the icons in accordance with a content of the evaluation performed by the evaluation unit.

2. The screen information processing apparatus according to claim 1, further comprising
an obtainment unit configured to obtain sensor information indicating a measurement result of each sensor, wherein
when an icon has been designated on the screen, the display control unit performs control of displaying, on the screen, the sensor information that corresponds to the icon.

3. The screen information processing apparatus according to claim 1, wherein
the display control unit performs control of displaying the auxiliary icon assigned with the number of the icons that have been grouped thereinto.

4. The screen information processing apparatus according to claim 1, wherein
when the auxiliary icon has been designated on the screen, the display control unit performs control of displaying an enlarged view of an arrangement area of the sensors that correspond to the auxiliary icon, together with the icons that correspond to the auxiliary icon.

5. The screen information processing apparatus according to claim 1, wherein
when the auxiliary icon has been designated on the screen on which a plan view of an arrangement area of the sensors has been displayed, the display control unit performs control of displaying a side view of the arrangement area of the sensors that correspond to the auxiliary icon, together with the icons that correspond to the auxiliary icon.

6. The screen information processing apparatus according to claim 1, wherein
when the auxiliary icon has been designated on the screen, the display control unit performs control of displaying a list of information of the sensors that correspond to the auxiliary icon.

7. The screen information processing apparatus according to claim 2, wherein
the sensors are provided in a plurality of types, and
the display control unit performs control of selectively displaying or selectively not displaying the icons that correspond to the sensor of the type designated on the screen.

8. A screen information processing method to be used in a screen information processing apparatus, the method comprising the steps of:
evaluating, when a plurality of icons respectively indicating positions of a plurality of sensors are to be displayed on a screen, an overlapping degree or crowdedness of the icons on the screen; and
performing control of displaying, on the screen, an auxiliary icon which is a separate icon that groups the icons in accordance with a content of the evaluation of the overlapping degree or the crowdedness.

9. A screen information processing program to be used in a screen information processing apparatus, the program causing a computer to execute the steps of:
evaluating, when a plurality of icons respectively indicating positions of a plurality of sensors are to be displayed on a screen, an overlapping degree or crowdedness of the icons on the screen; and
performing control of displaying, on the screen, an auxiliary icon which is a separate icon that groups the icons in accordance with a content of the evaluation of the overlapping degree or the crowdedness.
